(19) United States
(12) Patent Application Publication
(10) Pub. No.: US 2012/0042549 A1
(43) Pub. Date: Feb. 23, 2012

(54) LED illuminated header valance with front illumination and downward directional lighting

(76) Inventors: Richard Schattinger, New York, NY (US); Derek J. Gabriels, Bay Shore, NY (US)

(21) Appl. No.: 13/071,332

(22) Filed: Mar. 24, 2011

Related U.S. Application Data
(60) Provisional application No. 61/375,844, filed on Aug. 22, 2010.

(51) Int. Cl. G09F 13/04; F21S 4/00

(52) U.S. Cl. 40/541; 362/249.02

(57) ABSTRACT

A LED Illuminated header valance system to provide front illumination for graphic communication and downward lighting may include a transformer housing to power a LED light array, an extension arm housing to house the LED light array to provide a downward projecting light, a header mounting assembly to detachably connect the header valance system to the retail environment. The transformer housing may include a power cord to connect to a second header valance system, and the transformer housing may include a power outlet to connect to the power cord and the LED edge-lit panel.

### PRIORITY

The present invention claims priority based on 35 USC section 119 for a provisional application entitled LED illuminated header valance system which was filed on Aug. 22, 2010 with a Ser. No. of 61/375844 and an attorney docket number of WDS-6520.

### FIELD OF THE INVENTION

This invention is directed to an edge-lit backlighting and strip light system for light emitting diode displays, and, more particularly, to a strip light system employing a number of light strips in the form of thin, light weight sections of a substrate each of which mounts a plurality of light engines having an array of densely packed, primary color light emitting diodes (“LEDs”).

### BACKGROUND

In recent years, there have been developed light-emitting diodes capable of emitting red, green, and blue colors (hereinafter referred to as “RGB” in some cases) and light-emitting diodes which are formed of light emitting elements in combination with phosphor materials so that they emit various colors, such as a white color, with a high brightness. Since a light-emitting diode (hereinafter referred to as an “LED”) is a solid-state element, it has superior resistance against vibration, a low-power consumption rate, a long operating life, and superior drive properties such as a high-speed drive. Accordingly, the light-emitting diodes have been increasingly used for various applications such as light sources for signal heads and full-color LED displays.

Light-emitting diode devices having various sizes and display effects have been developed and are available in the market. Depending on the complexity of required illumination pattern, most of the light-emitting diode devices include arrays of light-emitting diodes selectively switched on/off to generate such illumination pattern. When a complex illumination pattern is desired, the number of required light-emitting diodes can be significant. In addition, when the light-emitting diode devices are applied to an educational toy, the educational value is limited to the image only.

### SUMMARY

A header valance system to provide front illumination for attachment to a retail environment may include a transformer housing to power a LED edge-lit panel and a light array, an extension arm housing to house the LED light array to provide a downward projecting light, a header mounting assembly to detachably connect the header valance system to the retail environment/fixturing.

The extension arm may include a transformer housing and may include a power cord to connect to a second header valance system, and the transformer housing may include a power outlet to connect to the power cord.

The LED edge-lit panel may include a power cord to connect to the transformer housing and provides illumination for the front graphic messaging/communication.

The extension arm housing may include a substantially straight extension arm.

The extension arm housing may include a substantially curved extension arm, and the header mounting assembly may include a side header panel to connect to the retail environment.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the LED illuminated header valance system of the present invention;

FIG. 2 illustrates a perspective view of the LED illuminated header valance system of the present invention;

FIG. 3 illustrates an exploded view of another LED illuminated header valance system of the present invention;

FIG. 4 illustrates a perspective view of the other LED illuminated header valance system of the present invention;

FIG. 5 illustrates a perspective view of the LED illuminated header valance system being mounted on the retail fixturing;

FIG. 6 illustrates a perspective view of the other header valance system mounted on the retail fixturing.

### DETAILED DESCRIPTION

The present invention is applicable to applications which may include retail environments in particularly the present invention may be used in health and beauty departments and is applicable to be used in almost any application.

The LED illuminated header valance system 100 of the present invention may be mounted directly to the existing retail gondola or other types of wall fixtures in order to provide a substantially front LED illuminated graphic/communication area with an extension arm housing 105 which may house LED modules or strip lighting for substantially downward lighting for the product or area below the LED illuminated header valance system.

Front Illuminated lighting may be achieved by using LED edge-lit panels (all available technologies) which may be positioned within the top and bottom channels 135 and 137 which may connect into a plug directly into an outlet found within the LED Extension arm housing/assembly 105(transformer housing).

The LED extension arm housing 105 may incorporate an outlet in its main assembly that powers the front LED Edge-lit Panel. The LED modules (LED Strip Lighting or LED Modules) may be held within the front curved structure of the extension arm housing 105 and the adjacent to the header mounting assembly 103.

The Extension Arm or Arms extending from its main assembly may be straight, curved or angled as the arm extends out for the substantially as downward directional lighting.

The lighting from the extension arm housing 105 may be achieved by incorporating LED Modules/LED Strip Lighting into the front curved structure which may be protected by a clear (transparent/translucent) extrusion profile.

Rigid side panels of the header mounting assembly 103 may allow the header electrical cords to run from one to the other end and may have bracket teeth that secure the structure of the LED edge lit header valance system 100 to the existing retail gondola fixtures or other types of wall fixtures.

The LED illuminated header valance system 100 may include top and bottom channels to hold the LED edge-lid panel and graphics in place, while allowing both to be removed and replaced.

The individual units of the LED illuminated header valance system 100 may be designed to plug one to the other side-to-side so that the user may have a continuous run which may ultimately plug into one standard wall electrical outlet. The low power requirements of the LED lights permit very long continuous runs without the need for multiple electrical outlets.

The LED illuminated header valance system 100 maybe formed into standard sizes to accommodate most retail environments, and this structure can be customized to different heights, widths, depths and shapes.

The LED illuminated header valance system 100 may be all LED based, resulting in an energy efficient, low power consumption, minimal heat, no mercury or heavy metals design with a longer life span than other types of lighting options.

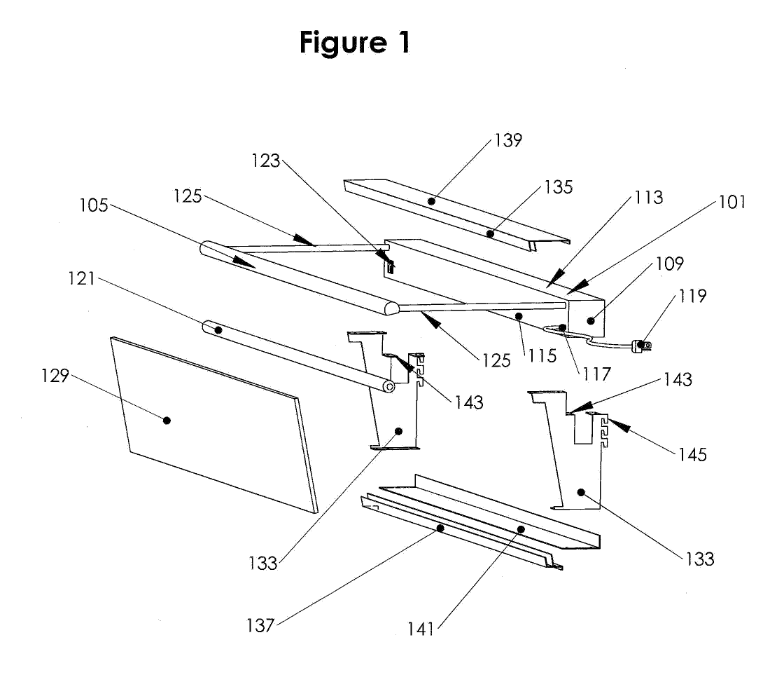

FIG. 1 illustrates an exploded view of the LED illuminated header valance system 100 of the present invention. The LED illuminated header valance system 100 may include a transformer housing 101, a header mounting assembly 103 and an extension arm housing 105 and may be formed from a rigid material such as metal, plastic or other appropriate material.

The transformer housing 101 may include a transformer front wall 107 which may be connected to a pair of opposing transformer sidewalls 109, a transformer back wall 111 which may be opposed to the transformer front wall 107 and may be connected to the opposing transformer sidewalls 109, a transformer top wall 113 which may be connected to the transformer front wall 107, the opposing transformer sidewalls 109 and the transformer back wall 111 and a transformer bottom wall 115 which may be opposed to the transformer front wall 107 and connected to the transformer front wall 107, the opposing transformer sidewalls 109 and the transformer back wall 111.

The transformer front wall 107 may include a transformer aperture 117 to cooperate with a power cord 119 to supply power to the power transformer (not shown) positioned within the transformer housing 101 to power the LED lights 121 and LED edge-lit panel 129. The transformer housing 101 may be hollow in order to accommodate the power transformer (not shown).

The transformer front wall 107 may also include a power outlet 123 to provide an electrical connection for and adjacent LED illuminated header valance system 100.

A pair of extension arms 125 may extend outwardly and substantially horizontally from the transformer front wall 107, and each of the extension arms 125 may be positioned on opposing sides of the transformer front wall 107. Each of the extension arms 125 may support and connect to an extension arm housing 105 which may include an array of LED lights 121 which may be formed into a strip of the LED lights 121 to illuminate the product or area below the LED illuminated header valances system 100.

The LED edge lit panel 129 may be a front panel for the header mounting assembly 103 and may be connected to a pair of opposing side header panels 133 and may be positioned in a top channel 135 and a bottom channel 137 so that the LED edge lit panel 129 may be removed and replaced to form a detachable connection with the head mounting assembly 103. The top channel 135 may be positioned on the bottom surface of the top header panel 139 and the bottom channel 137 may be positioned on the top surface of the bottom header panel 141 which may be opposed to the top header panel 139 and which may be connected to the side header panel 133 which may be connected to the top header panel 139.

The transformer housing 101 may be positioned against the shoulder 143 of the side header panel 133, and the back surface of the side header panel 133 may include an attachment device 145 which may be a multitude of downward extending hooks or other appropriate attachment device to attach to existing retail gondola fixture.

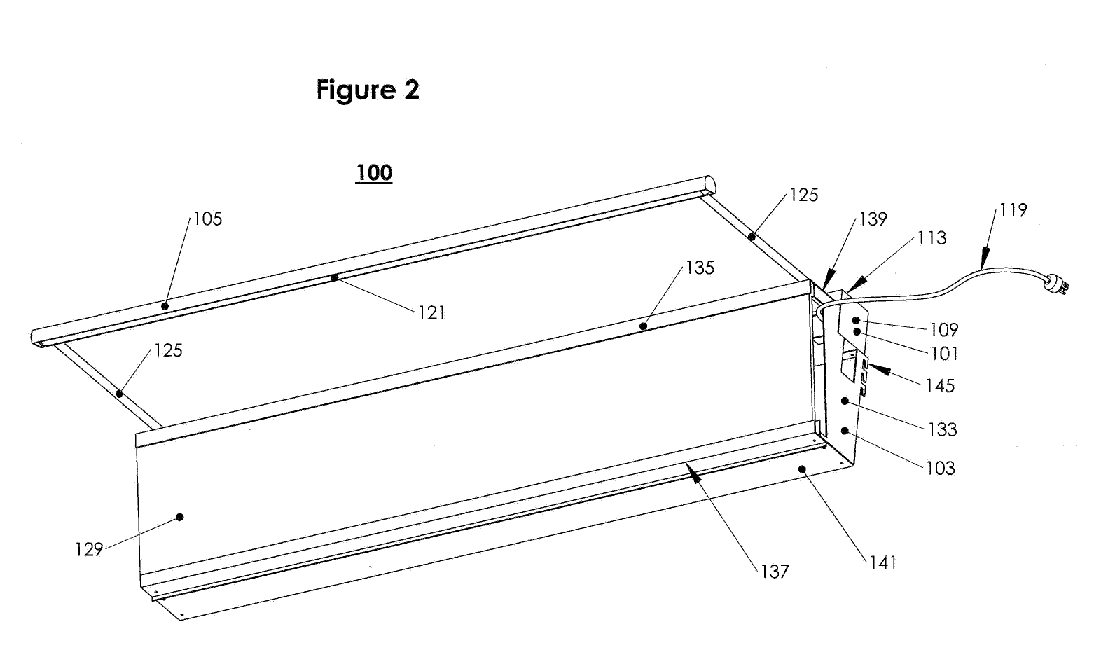

FIG. 2 illustrates a perspective view of the LED illuminated header valance system 100 of the present invention. The LED edge lit header valance system 100 may include a transformer housing 101, a header mounting assembly 103 and an extension arm housing 105 and may be formed from a rigid material such as metal, plastic or other appropriate material.

The transformer housing 101 may include a transformer front wall 107 (not shown) which may be connected to a pair of opposing transformer sidewalls 109, a transformer back wall 111 (not shown) which may be opposed to the transformer front wall 107 and may be connected to the opposing transformer sidewalls 109, a transformer top wall 113 which may be connected to the transformer front wall 107, the opposing transformer sidewalls 109 and the transformer back wall 111 and a transformer bottom wall 115 which may be opposed to the transformer front wall 107 and connected to the transformer front wall 107, the opposing transformer sidewalls 109 and the transformer back wall 111.

The transformer front wall 107 may include a transformer aperture 117 (not shown) to cooperate with a power cord 119 to supply power to the power transformer (not shown) positioned within the transformer housing 101 to power the LED lights 121. The transformer housing 101 may be hollow in order to accommodate the power transformer (not shown).

The transformer front wall 107 may also include a power outlet 123 (not shown) to provide an electrical connection for an adjacent LED illuminated header valance system 100 and front LED edge-lit panel 129.

A pair of extension arms 125 may extend outwardly and substantially horizontally from the transformer front wall 107, and each of the extension arms 125 may be positioned on opposing sides of the transformer front wall 107. Each of the extension arms 125 may support and connect to an extension arm housing 105 which may include an array of LED lights 121 which may be formed into a strip of the LED lights 121 to illuminate the product or area below the LED illuminated header valances system 100.

The LED edge lit panel 129 may be a front panel for the header mounting assembly 103 and may be connected to a pair of opposing side header panels 133 and may be positioned in a top channel 135 and a bottom channel 137 so that the LED edge lit panel 129 may be removed and replaced to form a detachable connection with the head mounting assembly 103. The top channel 135 may be positioned on the bottom surface of the top header panel 139 and the bottom channel 137 may be positioned on the top surface of the bottom header panel 141 which may be opposed to the top header panel 139 and which may be connected to the side header panel 133 which may be connected to the top header panel 139.

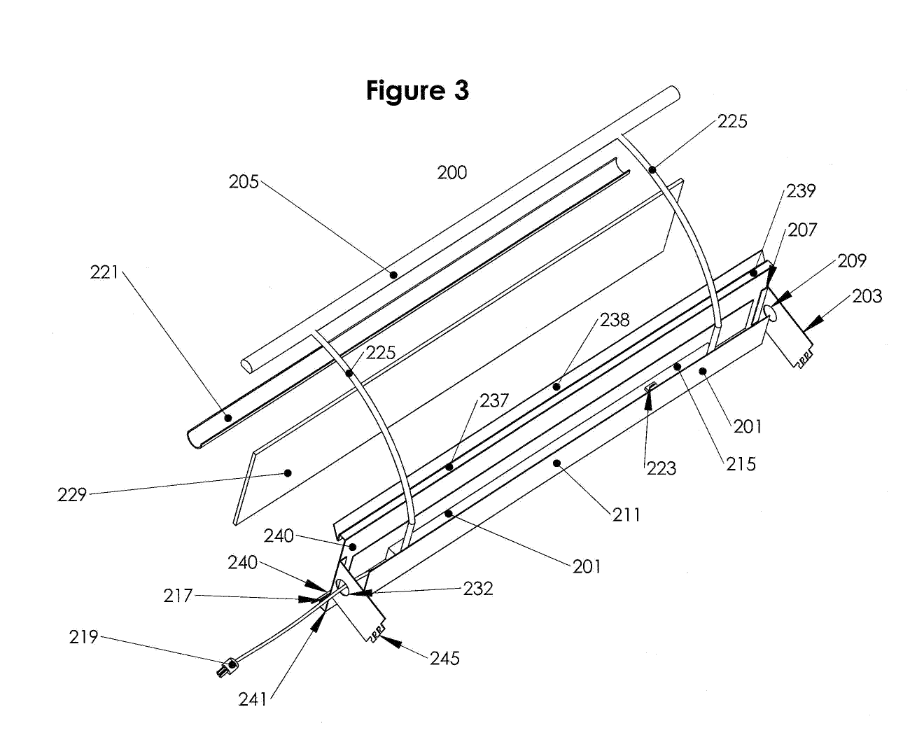

FIG. 3 illustrates an exploded view of the LED header valance system 200 for the product or area below the LED illuminated header valances system 100, of the present invention. The LED edge lit header valance system 200 may include a transformer housing 201, a header mounting assembly 203 and an extension arm housing 205 and may be formed from a rigid material such as metal, plastic or other appropriate material.

The transformer housing 201 which may be substantially U-shaped may include a transformer front wall 207, a transformer back wall 211 which may be opposed to the transformer front wall 207 and may be connected to a transformer bottom wall 215.

The side header panels 233 may include a transformer aperture 217 to cooperate with a power cord 219 to supply power to the power transformer (not shown) positioned within the transformer housing 201 to power the LED lights 221 and the LED edge-lit panel 129.

The transformer housing 201 may also include a power outlet 223 to provide an electrical connection for an adjacent LED edge lit header valance system 200.

A pair of extension arms 225 may extend and curve outwardly and from the transformer housing 201. Each of the extension arms 225 may support and connect to an extension arm housing 205 which may include an array of LED lights 121 which may be formed into a strip of the LED lights 221 to illuminate the product or area below the LED illuminated header valance system 100.

The LED edge lit panel 229 may be a front panel for the header mounting assembly 203 and may be connected to a pair of opposing side header panels 233 and may be positioned in a top channel 235 and a bottom channel 237 so that the LED edge lit panel 229 may be removed and replaced to form a detachable connection with the head mounting assembly 203. The top channel 235 may be positioned on the bottom surface of the top header panel 239 and the bottom channel 237 may be positioned on the top surface of the bottom header panel 241 which may be opposed to the top header panel 239 and which may be connected to the side header panel 233 which may be connected to the top header panel 239.

The bottom header panel 241 and the top header panel 239 may be integrally formed with a back header panel 240 which may be connected to the transformer housing 201.

The side header panel 233 may include an aperture 232 to allow a electrical connection with another LED illuminated header valance system 200.

The back surface of the side header panel 233 may include an attachment device 245 which may be a multitude of downward extending hooks or other appropriate attachment device to attach to existing retail gondola fixture.

FIG. 3 illustrates an upward extending member 238 which may upwards extend from the front surface of the top header panel 239 which includes the top channel 235 and a downward extending member 240 which extend downward from front surface of the bottom header panel 241 which includes the bottom channel 237.

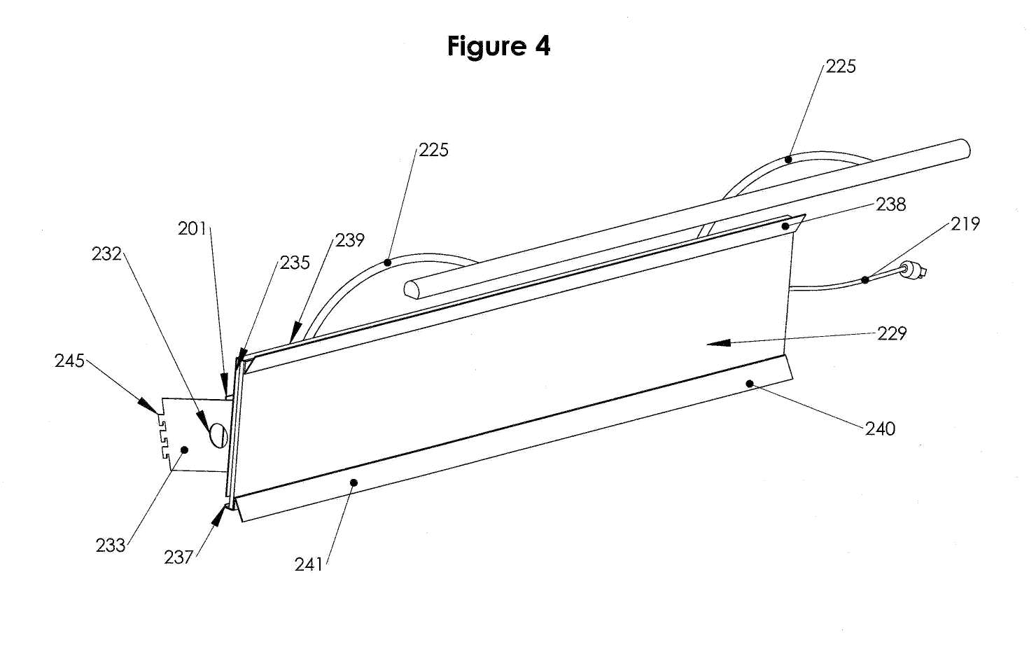

FIG. 4 illustrates an upward extending member 238 which may upwards extend from the top panel 235 and a downward extending member 240 which extend downward from the bottom channel 237. FIG. 4 additionally illustrates the LED edge lit panel 229 which may be positioned between the top channel 235 and the bottom channel 237.

The side header panel 233 may include an aperture 232 to allow a electrical connection with another header valance system 200 and may include an attachment device 245 which may be a multitude of downward extending hooks or other appropriate attachment device to attach to existing retail gondola fixture. FIG. 4 additionally illustrates the extension arms 225 which may be substantially straight, angled or curved or other geometries and the extension arm 205.

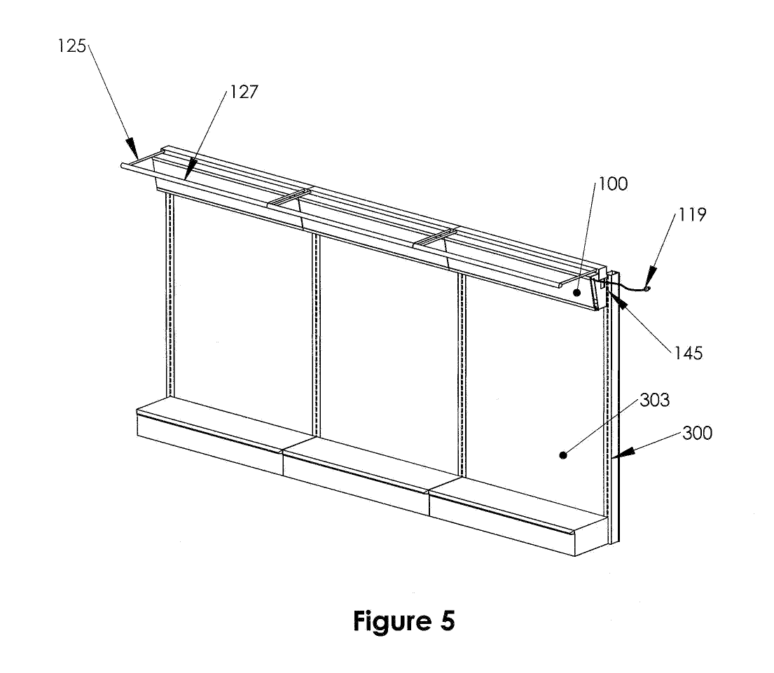

FIG. 5 illustrates the LED illuminated header valance system 100 attached to an existing retail gondola fixture 300 and illustrates the power cord 119, the extension arm 125, the light housing 127, a retail gondola fixture or back wall section 303 to be lit by the LED lights 121 within the light housing 127, and the side header panel 133 which may include the attachment device 145. The LED edge-lit panel 129 illuminates a front area for graphic communication.

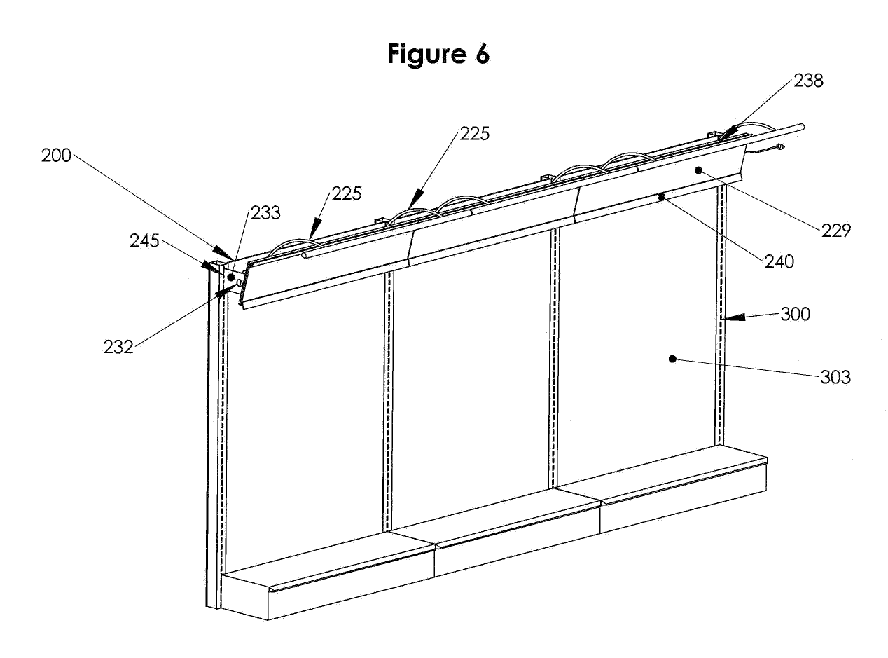

FIG. 6 illustrates the LED edge lit header valance system 200 attached to an existing retail gondola fixture 300 and illustrates the power cord 219, the extension arm 225, the light housing 127, a retail gondola fixture or back wall section 303 to be lit by the LED lights 221 within the light housing 227, and the side header panel 233 which may include the attachment device 245. The LED edge-lit panel 129 illuminates a front area for graphic communication.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A LED illuminated header valance system to provide front illumination for attachment to a retail environment/fixturing, comprising:
a transformer housing to power a LED light array and LED edge-lit panel;
an extension arm housing to house the LED light array to provide a downward projecting light;
a header mounting assembly to detachably connect the header valance system to the retail environment.

2) A LED illuminated header valance system to provide front illumination for graphic communication and downward lighting for attachment to a retail environment as in claim 1, wherein the transformer housing includes a power cord to connect to a second header valance system.

3) A LED illuminated header valance system to provide front illumination for graphic communication and downward lighting as in claim 2, wherein the transformer housing includes a power outlet to connect to the power cord.

4) A LED illuminated header valance system to provide front illumination for graphic communication and downward lighting as in claim 1, wherein the extension arm housing the LED light array.

5) A LED illuminated header valance system to provide front illumination for graphic communication and downward lighting as in claim 4, wherein the top and bottom channels hold the LED edge-lit panel and graphic.

6) A LED illuminated header valance system to provide front illumination for graphic communication and downward lighting as in claim 5, wherein the top and bottom channels hold the LED edge-lit panel and graphic.

7) A LED illuminated header valance system to provide front illumination for graphic communication and downward lighting as in claim 1, wherein the extension arm housing includes a substantially straight extension arm.

8) A LED illuminated header valance system to provide front illumination for graphic communication and downward lighting as in claim 1, wherein the extension arm housing includes a substantially curved extension arm.

9) A LED illuminated header valance system to provide front illumination for graphic communication and downward lighting as in claim 1, wherein the header mounting assembly includes a side header panel to connect to the retail environment.

10) A LED illuminated header valance system to provide front illumination for graphic communication and downward lighting as in claim 9, wherein the side header panel includes a downward extending hook to connect to the retail environment.
